(19) United States
(12) Patent Application Publication
(10) Pub. No.: US 2014/0356267 A1
(43) Pub. Date: Dec. 4, 2014

(54) PROCESS AND SYSTEM FOR CAPTURING CARBON DIOXIDE FROM A GAS STREAM

(71) Applicant: Richard J. Hunwick, Roseville (AU)

(72) Inventor: Richard J. Hunwick, Roseville (AU)

(21) Appl. No.: 14/350,029

(22) PCT Filed: Oct. 5, 2012
(86) PCT No.: PCT/AU2012/001215

§ 371 Date: Jul. 7, 2014

(30) Foreign Application Priority Data
Oct. 7, 2011 (AU) 2011904159

(51) Int. Cl. B01D 53/96; B01D 53/62

(52) U.S. Cl. CPC B01D 53/96; B01D 53/62
USPC 423/220; 422/170

(57) ABSTRACT

A process and system are disclosed for capturing carbon dioxide from a gas stream. The process and system comprises a first reactor in which a slurry of a metal silicate is reacted together with an ammonium salt in aqueous solution. The salt is one that does not form a precipitate with the metal silicate. In the first reactor the metal silicate reacts with the solution to produce a slurry of silica in an aqueous solution of a salt of the metal and ammonia. Ammonia gas is drawn off directly from the first reactor, and ammonia, including the ammonia drawn off from the first reactor, is added to the gas stream. The process and system also comprises scrubbing the gas stream, including with the added ammonia, with an aqueous solution, whereby the carbon dioxide and ammonia are absorbed into the solution and ammonium carbonate salt(s) are produced.

### TECHNICAL FIELD

A process and system are disclosed for capturing carbon dioxide from a gas stream. The gas stream may originate as flue gas from coal-fired power stations or may originate from other point sources such as power stations fired by other fossil fuels including natural gas, as well as steel mills, cement plants and other industrial sites including oil and metal refineries, or from the burning of other fuels containing carbon including biomass-derived fuels such as alcohols, agricultural residues and biogas.

### BACKGROUND ART

There is increased focus on reducing carbon dioxide emissions to the atmosphere, to help minimise the effects of global warming. Carbon dioxide sinks exist naturally, including the weathering of silicate rocks to form carbonates, and the world's oceans. Plants are also an effective form of carbon dioxide sink and use photosynthesis to remove carbon from the atmosphere by incorporating it into biomass. However, these naturally occurring sinks are not capable of effectively keeping up with the vast quantities of carbon dioxide being produced in today's power-thirsty climate.

While as indicated there are many point sources, the major type of such sources of excess carbon dioxide gases are large fossil fuel power stations which, when fuelled by black coal, on average typically output around 0.8 to one tonne of the gas for each MegaWatt-hour (MWh) of electricity they generate. For example, a large power station such as the 2,640 MW Bayswater in the Hunter Valley of New South Wales, Australia, in generating 20 million MWh of electricity in a year, would also output 18 million tonnes of carbon dioxide. It would be advantageous if there was a system and method which was capable of capturing and permanently sequestering at least some of the carbon dioxide emitted from such power stations. It would also be advantageous if a system and method were provided for the disposition of the gas to be independently audited in perpetuity.

AU 2008217572 to the present applicant discloses a system, apparatus and method for sequestering carbon dioxide. In the method of AU 2008217572 a metal silicate rock is mined, milled, and formed into a slurry to be transported by pipeline from the rock mine/quarry to the point source of the carbon dioxide containing gas. The slurry is sprayed into an ammonia absorber where it contacts and reacts with ammonia gas to produce a slurry comprised of the metal silicate dispersed in a solution primarily of ammonia in water. This slurry is then transferred into a scrubber into which the carbon dioxide-containing gas is fed to be scrubbed. The slurry is sprayed in an upper zone of the scrubber and is used to capture the carbon dioxide therein. The aqueous phase of the slurry becomes a solution of ammonium carbonate salts including ammonium bicarbonate NH₄HCO₃, and normal ammonium carbonate (NH₄)₂CO₃, together with smaller quantities of ammonium carbamate NH₄COONH₂, and urea CO(NH₂)₂. This slurry is then transported by pipeline from the scrubber back to the rock mine/quarry and, in this regard, the pipeline forms a reactor in which the ammonium carbonate salts in solution react with the metal silicate rock dispersed in the slurry to form a metal carbonate plus silica, which are both insoluble in the solution, plus ammonia, which remains in solution mainly as ammonium hydroxide. At the rock mine/quarry the ammonia is separated from the metal carbonate/silica slurry and is then returned by pipeline to the ammonia absorber at the point source. The metal carbonate/silica solids are returned to the mine/quarry as clean fill.

In the method of AU 2008217572 the apparatus must be capable of pumping slurries of relatively high solids loading at elevated temperatures and pressures over long distances. In addition, insoluble metal carbonates formed during the key carbonation reaction may act to coat and hence passivate the surfaces of the metal silicate rock particles and thereby slow the conversion of metal silicates to metal carbonates. In addition, where the conversion of metal silicates to carbonates plus silica in the pipeline or other reactor is incomplete, the recovery of ammonia is rendered more difficult because the thermal processes used can cause substantial production of carbon dioxide from the decomposition of unreacted ammonium carbonate/bicarbonate.

The above references to the background art do not constitute an admission that the art forms a part of the common general knowledge of a person of ordinary skill in the art. The above references are also not intended to limit the application of the process and system disclosed herein.

### SUMMARY OF THE DISCLOSURE

Disclosed herein is a process for capturing carbon dioxide from a gas stream. The gas stream may originate as flue gas from coal- and other carbon-containing fuel-fired power stations (e.g. fossil fuels such as natural gas, biomass-derived fuels such as alcohols, agricultural residues, biogas, etc). The gas stream may originate from other point sources such as steel mills, cement plants, oil and metal refineries, etc. The gas stream may contain other off gases. For example, carbon dioxide may be only a minor component of the gas stream. In this regard, in the case of a coal-fired power station, the primary constituent of the flue gases is atmospheric nitrogen.

The process comprises reacting in a first reactor a slurry of a metal silicate together with an ammonium salt in aqueous solution.

To prevent fouling of the first reactor and to enable further processing of the slurry, an ammonium salt is selected that does not form a precipitate with the metal silicate. For example, whilst a usual ammonium salt in solution may be ammonium chloride NH₄Cl, due to its availability and ease of handling, the ammonium salt may comprise other ammonium salts as ammonium sulphate (NH₄)₂SO₄, ammonium nitrate NH₄NO₃, or a blend of any or all of these ammonium salts. Ammonium sulphate and ammonium nitrate may be by-products of the scrubbing, by solutions or slurries containing ammonia, of carbon dioxide from flue gases from e.g. coal-fired power stations.

Further, the first reactor is generally controlled so that the solution is substantially free of salts such as ammonium carbonate (NH₄)₂CO₃, bicarbonate NH₄HCO₃, carbamate NH₄COONH₂, urea CO(NH₂)₂, or other ammonium salts capable of forming insoluble metal carbonate precipitates in the first reactor.

The first reactor is operated such that the metal silicate reacts with the solution to produce a slurry of silica in an aqueous solution of a salt of the metal and ammonia. Initially, the slurry may comprise ammonia and ammonium salts in solution that form an ammonia/ammonium salt/metal silicate/water slurry which is then caused to react. For example, the conditions in the first reactor may be controlled whereby the ammonium salt partially decomposes, and ammonia formed as a decomposition product is driven out of solution as a gas.

The process also comprises drawing off ammonia gas directly from the first reactor. This contrasts with the process of AU 2008217572 in which ammonia gas must be separated out of the slurry leaving the pipeline in a separate gas recovery vessel.

The process also comprises adding ammonia, including the ammonia drawn off from the first reactor, to the gas stream. In this regard, the ammonia and gas stream containing carbon dioxide (e.g. power station flue gas) may each be individually added (e.g. by being fed or injected) into a scrubbing vessel. Alternatively, the ammonia and carbon dioxide-containing gas stream may be pre-mixed and then added (e.g. fed or injected) into the scrubbing vessel. In another alternative, the ammonia and carbon dioxide-containing gas stream may be added into an aqueous scrubbing solution that is circulating in the scrubbing vessel. This also contrasts with the process of AU 2008217572 in which ammonia gas is first fed into a dedicated ammonia absorber where it contacts and reacts with the slurry of metal silicate to produce a solution of ammonia/ammonium salt/metal silicate/water. Only after the ammonia absorber stage is the solution then used to scrub the carbon dioxide containing gas.

The process also comprises scrubbing the gas stream, including with the added ammonia, with an aqueous solution. The carbon dioxide in the gas stream together with the added ammonia are absorbed into the solution and ammonium carbonate salt(s) are produced (e.g. ammonium carbonate and ammonium bicarbonate).

The process is able to be arranged whereby the first reactor may be located at a mine or quarry site for the metal silicate, whereas a scrubbing apparatus is located at a point source (e.g. power station) for the carbon dioxide-containing gas stream. In addition, only ammonia gas may be sent (e.g. piped) from the first leach reactor to scrubbing apparatus at the point source. In addition, only an ammonium carbonate solution produced at the scrubbing apparatus may be sent (e.g. piped) back to mine or quarry site. Thus, the pumping/transporting of mineral slurries that occurs with the process of AU 2008217572 can be eliminated.

The first reactor may be designed to facilitate one or other of the variants of the following reactions shown between the ammonium salts and the metal silicate rock (e.g. when the metal silicate rock comprises magnesium silicate minerals such as serpentine Mg₃Si₂O₅(OH)₄ (equation (1a)) or the mineral olivine Mg₂SiO₄ (equation (1b)), or the calcium silicate mineral wollastonite CaSiO₃ (1c)):

Mg₃Si₂O₅(OH)₄+6NH₄Cl+H₂O→3MgCl₂+2SiO₂+6NH₄OH (1a)

Mg₂SiO₄+4NH₄Cl+2H₂O→2MgCl₂+SiO₂+4NH₄OH (1b)

CaSiO₃+2NH₄Cl+H₂O→CaCl₂+SiO₂+2NH₄OH (1c)

While equations (1a), (1b) and (1c) show the reaction for ammonium chloride NH₄Cl, the ammonium salt may be other soluble salts as mentioned above (e.g. (NH₄)₂SO₄, NH₄NO₃) in which case the equations would change accordingly.

In one embodiment the metal silicate and the ammonium salt solution may be reacted in the first reactor at an elevated pressure and at an associated elevated temperature, for example, which is near the boiling point of the solution at that pressure. This can increase the speed of the reactions shown in Equations (1a), (1b) and (1c). By way of example, if the pressure in the first reactor is controlled to be around 25 Bar, the temperature in the first reactor will be maintained at a temperature of the order of 220° C. Under these conditions some of the ammonia is driven out of solution as a gas, and this may occur together with some water vapour (i.e. the solution boils) according to:

NH₄cl→NH₄⁺+Cl⁻→NH₃↑+H⁺+Cl⁻

Thus, the liquid-phase contents of the first reactor can become enriched in hydrogen ions, making them more acidic (the pH number is lowered), leading to an acceleration in the rates of reaction of Equations (1a), (1b) and (1c), which may now be written as follows:

Mg₃Si₂O₅(OH)₄+6H⁺+6Cl⁻→3MgCl₂+2SiO₂+5H₂O (1d)

Mg₂SiO₄+4H⁺+4Cl⁻→2MgCl₂+SiO₂+2H₂O (1e)

CaSiO₃+2H⁺+2Cl⁻→CaCl₂+SiO₂+H₂O (1f)

Ammonia is seen to take no part in these reactions, which occur in the liquid phase.

In one embodiment the ammonia gas drawn from the first reactor may be separated from such water vapour in a distillation column. The separated water vapour may be condensed, and at least some of the condensed water may be returned to the first reactor. In one embodiment, the products of the reactions shown on the right-hand sides of Equations (1a), (1b) and (1c) (but without the ammonia, which has been substantially boiled out of the solution), (or Equations (1d), (1e) and (1f)), namely, the metal salt in solution and silica slurry, may be passed to a second reactor. In the second reactor the metal salt in solution may be reacted with the solution of ammonium carbonate salt(s) produced in and returned from scrubbing the carbon dioxide-containing gas stream.

The reaction in the second reactor can be operated to cause a metal carbonate precipitate to form and to also regenerate the ammonium salt in aqueous solution. The metal carbonate precipitate may be separated from the regenerated ammonium salt in aqueous solution, the latter of which may be recycled to the first reactor (i.e. for reuse in reacting with the metal silicate).

The metal salt in solution or slurry (i.e. depending on whether the silica is still present) reacts with the ammonium carbonate (see Equations (2a) and (2b) below) to form a metal carbonate precipitate. For example, insoluble magnesium carbonate in the form of the mineral magnesite MgCO₃ forms from the magnesium salts present (Equation (2a)), or insoluble calcium carbonate CaCO₃ (in forms such as the minerals calcite or aragonite or travertine) forms from the calcium salts present (Equation (2b)):

MgCl₂+(NH₄)₂CO₃→MgCO₃+2NH₄Cl (2a)

CaCl₂+(NH₄)₂CO₃→CaCO₃+2NH₄Cl (2b)

The reaction in the second reactor may be controlled to occur at similar pressures to the first reactor (e.g. to maintain temperatures in the second reactor above 150° C.). At lower temperatures (e.g. below 150° C.) hydrated forms of magnesite including the mineral nesquehonite (MgCO₃.3H₂O) may precipitate out, which are less desirable for the permanent storage of carbon dioxide in mineral form.

In one embodiment the insoluble silica may be filtered or otherwise separated from the aqueous phase prior to the second reactor for purposes including the production of a potentially valuable porous silica product that may find separate markets, and to leave a substantially clear metal salt solution rather than slurry. In another embodiment the silica may be allowed to remain in the product of the first reactor as this proceeds to the second reactor, and then to subsequent separation stage(s) without affecting the chemistry of the overall process.

In one embodiment, at least one of pressure and heat may be exchanged between the slurry/solution fed to the first reactor and the solution leaving the second reactor (e.g. by using a heat exchanger sets and pump/head-recovery turbine sets). These sets can allow for the energy-efficient control of the pressure and temperature in the first reactor.

For example, the metal carbonate precipitate and the insoluble silica (if the latter has not already been separated out before this stage) may be separated from the regenerated ammonium salt solution in one or more thickening and/or filtration stages subsequent to the second reactor. The thickening stages may optionally comprise an internal recycle of overflow solution to improve recovery.

In one embodiment, the ammonia gas and accompanying water vapour from the first reactor may be passed under pressure to the distillation column. In the distillation column, the stream may be divided into an ammonia-rich gas stream that may emanate from a top of the distillation column, and an ammonia-depleted water-rich bottoms stream that may emanate from a bottom of the distillation column. The water-rich bottoms stream may be returned in part or in full to the first reactor, although some water may be withdrawn for other process purposes.

In one embodiment, the ammonia gas from the distillation column may be condensed (e.g. under pressure such as at least 15 Bar) to a liquid at ambient temperatures. The condensed ammonia may be transferred as a liquid from the site of the distillation column to e.g. the site of the point source of carbon dioxide (e.g. power station or other).

For example, one or more pipelines may transport the liquid ammonia under pressure to the point source of carbon dioxide. The length of the pipeline(s) can be determined by how far apart are the point source and the serpentinite or other rock mine/quarry (e.g. they may be 200 kilometres, or more, apart).

Prior to use in scrubbing, the ammonia liquid may be allowed to expand to be fed as a gas to the scrubbing stage to scrub the gas stream. For example, the liquid ammonia may be passed through a pressure-reduction valve, wherein the pressure of the ammonia may be allowed to fall to near atmospheric pressure. In this case, the liquid ammonia (which is normally a gas at ambient temperatures and pressures) immediately starts to flash to vapour. The latent heat of vaporization of the ammonia flashing to vapour is drawn from the initially liquid ammonia, chilling the resulting gas plus liquid (i.e. mist) stream to temperatures well below the freezing point of water.

In one embodiment, the ammonia passing from the pressure-reduction valve may be passed to a chamber that encloses banks of tubes through which the scrubbing solution passes (e.g. a shell and tube heat exchanger). For example, the tubes may be externally fitted with fins to increase their effective heat transfer surface area. As the ammonia (a mixture of sub-zero vapour (gas) and boiling liquid) passes through the chamber it may cool the scrubbing solution in the tubes, with a total cooling effect optionally being allowed to continue until all remaining ammonia liquid boils to gas.

In one embodiment, the now gaseous-phase ammonia may e.g. be injected into a gas stream containing the carbon dioxide (e.g. flue gases from a coal-fired power station or a gas stream product of a water gas shift reactor, which optionally has been fed with syngas, or a stream of raw natural gas that is contaminated with carbon dioxide). Such injection may occur prior to or in a scrubbing vessel. Usually, such flue gases have already been substantially cleaned of e.g. fly ash solids by passage through known fabric filters or electrostatic precipitators.

In one embodiment, an aqueous solution may be circulated in the scrubbing vessel through banks of deluging sprays, and the carbon dioxide-containing gas (e.g. power station flue gas) and ammonia, either individually or pre-mixed, may be fed or injected into the scrubbing vessel, or may be fed or injected into the aqueous solution. In any case, the exposure of the carbon dioxide-containing gas and ammonia to the spray or deluge can maximise the area of exposure between the circulating solution and the gas mixture. In another embodiment, the scrubbing vessel may be configured such that the solution flows down through packing or trays designed to maximise the area of exposure between the solution and the gas mixture.

The ammonia, being highly soluble in water, is rapidly absorbed into the circulating aqueous solution, forming a solution that is rich in ammonia, and further enhancing CO) absorption.

The ammonia can be present in the solution as both molecular ammonia NH₃, and as ammonium hydroxide NH₄OH, by virtue of the equilibrium reaction:

NH₃+H₂O←→NH₄OH (3a)

Both forms of ammonia in the solution may rapidly absorb (scrub) the carbon dioxide present in the gas stream, to produce ammonium bicarbonate according to:

NH₄OH+CO₂→NH₄HCO₃ (3b)

In the presence of excess ammonia, the normal carbonate can form according to:

NH₄HCO₃+NH₃→(NH₄)₂CO₃ (3c)

Thus, the circulating solution with make-up water can rapidly become a solution of ammonium carbonate and bicarbonate in water (i.e. a solution of “ammonium carbonate salt(s)”).

In one embodiment, the circulation of the solution may be arranged such that upper zones of the scrubbing vessel (or those zones otherwise last in contact with the flue gases prior to their discharge to atmosphere) may be scrubbed by a solution that has the lowest concentration of ammonia in solution. This solution may pass through the heat exchanger (e.g. through the banks of tubes) cooled by the ammonia chilled following its passage through the pressure reduction valve. Thus, prior to leaving the scrubbing vessel, the flue gases may be cooled and de-humidified so that the partial pressure of free ammonia gas in these gases is so low as to be below limits normally imposed for the concentration of free ammonia in gases discharged to the atmosphere. For example, the process may allow for free ammonia concentrations to be kept below one part per million by volume in the scrubbed gases finally discharged to the atmosphere.

In one embodiment, in the lower zones of the scrubbing vessel, ammonia concentrations and temperatures can be higher, whereat most of the carbon dioxide may be removed from the gases containing carbon dioxide. When carbon dioxide reacts with an aqueous solution containing ammonia to form ammonium carbonate and bicarbonate in solution, substantial quantities of heat are liberated.

In one embodiment, this heat of solution may be removed by first passing the circulating solution through banks of tubes in another heat exchanger. In this case the other heat exchanger may be cooled by e.g. circulating cooling water (i.e. prior to returning the solution to the scrubber).

In one embodiment, this cooling water may in turn be cooled in a conventional evaporative (wet), or non-evaporative (dry), or hybrid wet-dry cooling tower.

In one embodiment, in e.g. a base of the scrubbing vessel, a pool of circulating ammonium carbonate solution (i.e. ammonium carbonate salt(s)) may be formed. A portion of this may be recirculated in the scrubber, and a portion may be drawn or separated off for returning to the second reactor. The portion returned to the second reactor may comprise surplus ammonium carbonate solution (e.g. equal in mass to the make-up water, plus ammonia, plus carbon dioxide and other gases removed from raw flue gases). This portion may be pumped from the base of the scrubbing vessel and overland to the mine site (e.g. over considerable distances, say in excess of 200 kilometres). A reference herein to make-up water is a reference to that water that is added to the circulating aqueous solution in the scrubber to maintain a correct quantity of water in the gas scrubbing system (i.e. after accounting for water that is condensed from flue gases entering the scrubber, and the water component of the aqueous ammonium carbonate solution that is pumped overland to the mine site).

In one embodiment, an appropriate quantity of compressed air may be blown or otherwise dispersed through this solution. This can cause sulphite ions (when present in solution—e.g. formed from sulphur dioxide originally present in flue gases that were formed in turn from the combustion of reduced forms of sulphur in coal or other fuel) and nitrite ions (when present in solution—e.g. formed from the reaction at high temperatures between oxygen and nitrogen in air, together with the combustion of any nitrogen-containing matter in the coal or other fuel) to form sulphate and nitrate ions in solution respectively.

Thus, in addition to capturing carbon dioxide in the gas stream, the process can be adapted to capture the SOx and NOx (when present) in the gas stream (i.e. by forming nitrate and sulphate salts of ammonia as mentioned above).

In one embodiment, the metal silicate rock may be pre-treated to allow the reaction described by Equations (1a), (1b) and (1c) to proceed at an economically acceptable rate.

In one embodiment, the silicate rock may be a serpentinite rock (i.e. comprised of the serpentine minerals antigorite and/or lizardite and/or chrysotile). The serpentinite rock may be ground to −200 microns particle size in a combination of equipment items including high-pressure grinding rolls and ball mills.

In one embodiment, the metal silicate may comprise a magnesium-rich silicate such as serpentine and/or olivine and/or pyroxene mineral (i.e. ultrabasic or ultramafic minerals).

In one embodiment, the ammonium salt in aqueous solution reacted in the first reactor may primarily comprise ammonium chloride. The ammonium chloride may be produced from the reaction of ammonium carbonate (a product of the scrubbing process) with common salt (sodium chloride).

For example, a proportion of the solution of ammonium carbonate salt(s) that is to be passed from the scrubbing stage to the second reactor may be separated (e.g. the stream may be split). This proportion may then be used to produce an aqueous ammonium salt solution in a separate process stage for eventual recycle to the first reactor.

In one embodiment the separate process stage may comprise an ammonium chloride manufacturing process. In this process stage, the separated proportion of ammonium carbonate salt(s) solution may be mixed together with common salt in the form of a brine. This mixed solution may then also be used to scrub a gas comprising carbon dioxide. The carbon dioxide is absorbed and reacts with the ammonium carbonate salt(s) such that the predominant ammonium salt present in the solution is ammonium bicarbonate, as follows:

(NH₄)₂CO₃+CO₂+H₂O→2NH₄HCO₃ (4)

The ammonium bicarbonate reacts with the sodium chloride in the brine solution (Equation (5)) with the result that a precipitate of sodium bicarbonate is formed, because this salt is only sparingly soluble in this solution.

NH₄HCO₃+NaCl→NaHCO₃+NH₄Cl (5)

After the sodium bicarbonate has been filtered out and washed of any adhering solution, an aqueous ammonium chloride solution remains, which may be passed to the first reactor, where it may be made to react with fresh metal silicate rock according to Equations (1a), (1b) or (1c).

The sodium bicarbonate precipitate formed may be heated to produce soda ash:

2NaHCO₃→Na₂CO3+H₂O+CO₂ (6)

A gas stream of carbon dioxide and water vapour can be liberated. This gas stream may be recycled to react with and be scrubbed by the ammonium carbonate salt(s) and brine solution according to Equation (4).

In the separate process stage, the gas stream may further comprise a slip stream taken from the original (e.g. flue) gas stream to be scrubbed with ammonia in the scrubbing stage at the point source.

In a further variation of the separate process stage, the ammonium chloride solution which is separated from the sodium bicarbonate precipitate may be mixed with the metal silicate. Optionally, it may also be mixed with the ammonium salt solution regenerated in the second reactor. This mixture can react according to Equations (1a), (1b) or (1c) to produce a solution comprising ammonium chloride which may also be passed to the first reactor.

In one embodiment, the first and/or second reactor may comprise two or more stirred tanks or other vessels interconnected in series; or a pipeline or series of pipelines; or a combination of the stirred tank(s)/vessel(s) and pipeline(s) interconnected in series. The tank(s)/vessel(s) and/or stirred pipeline(s) may be located in use underground, at a depth that provides sufficient pressure by way of static head to enhance the reaction between the metal silicate and ammonium salt, or the precipitation reaction between the metal in solution and carbonate.

Also disclosed herein is a system for enabling carbon dioxide in a gas stream to be captured. The system comprises a first reactor for receiving and controlling the reaction of a metal silicate slurry with an ammonium salt in aqueous solution. As with the process set forth above, an ammonium salt that does not form a precipitate with the metal silicate is fed to the first reactor. In the first reactor the metal silicate reacts with the solution to produce a slurry of silica in an aqueous solution of a salt of the metal and ammonia. The system also comprises a second reactor for receiving the solution of the metal salt from the first reactor and for controlling its reaction with a solution of ammonium carbonate salt(s) to form a metal carbonate precipitate and to regenerate the ammonium salt in aqueous solution for use in the first reactor.

As with the process set forth above, the ammonium carbonate solution may represent a “captured form” of carbon dioxide (e.g. as produced in the scrubbing apparatus).

The system may also comprise a separation stage for recovering the ammonium salt solution for re-use in the first reactor, i.e. to separate the ammonium salt-rich aqueous phase from the insoluble metal carbonate and silica phases. The separation stage may, for example, comprise thickeners and/or filters (as with the process set forth above).

In the system the ammonium carbonate solution for passing to the second reactor may be produced in a scrubbing apparatus. The scrubbing apparatus may also form part of the system and may be employed for removing carbon dioxide from a gas stream emanating from a point source (e.g. a fossil fuel-fired power station, etc). In the scrubbing apparatus the carbon dioxide can be absorbed in an ammoniated solution that may be produced from ammonia gas. Optimally, the ammonia gas may include ammonia gas drawn from the first reactor.

The scrubbing apparatus may be operated in a manner as set forth in the process disclosed above. For example, the concentration of ammonia in any gases discharged to the atmosphere can be controlled to limit this to low levels for example to less than one part per million by volume. In addition, the first and/or second reactors may be as defined for the process disclosed above.

The system may further comprise either or both of a heat exchanger and pump/head-recovery turbine. Each of the exchanger and turbine may be arranged to operate such that at least one of pressure and heat may be exchanged between the slurry/solution fed to the first reactor and leaving the second reactor. The exchanger and turbine may be used to control pressure and temperature in the first reactor and thus in the second reactor.

The system may further comprise an ammonium chloride manufacturing stage. This stage can be employed to accommodate any minor losses of ammonium chloride that may occur in the process disclosed herein.

The ammonium chloride manufacturing stage may comprise a mixing vessel in which part of the solution of ammonium carbonate salt(s) destined for the second reactor is instead mixed together with brine. The ammonium chloride manufacturing stage may also comprise a scrubbing vessel in which the mixed solution of ammonium carbonate salt(s) and brine is used to scrub a gas comprising carbon dioxide, and to produce an aqueous ammonium chloride solution for passing to the first reactor. This gas can be produced in the ammonium chloride manufacturing stage and may also further comprise a slip stream taken from a gas stream emanating from the point source.

In the ammonium chloride manufacturing stage the scrubbing vessel can be operated such that the carbon dioxide is absorbed into the mixed solution to react with the ammonium carbonate to produce ammonium bicarbonate (Equation (4)). The ammonium bicarbonate can in turn react with the chloride of the brine to produce ammonium chloride and a sodium bicarbonate precipitate (Equation (5)).

The ammonium chloride manufacturing stage may further comprise sodium bicarbonate separation and heating stages.

In the separation stage the sodium bicarbonate precipitate can be separated from solution circulating in the scrubbing vessel. For example, firstly this solution can be passed via a hydrocyclone where the sodium bicarbonate precipitate and a small proportion of solution is separated off, with the remainder fed back to the scrubbing vessel. Secondly, the sodium bicarbonate precipitate and small proportion of solution can be passed to a rotary vacuum filter to separate off the sodium bicarbonate crystals.

In the heating stage the sodium bicarbonate precipitate from the rotary vacuum filter may be heated in e.g. a rotary dryer. This can produce soda ash and can liberate a gas stream of carbon dioxide and water vapour (Equation (6)). This gas stream may then be recycled to the scrubbing vessel where the carbon dioxide is scrubbed by and reacts with the mixed solution.

The ammonium chloride manufacturing stage may further comprise an ammonium chloride top-up stage. In this stage the ammonium chloride solution which is separated at the rotary vacuum filter may be passed to an additional mixing vessel. Here it may be mixed with the metal silicate (i.e. which would otherwise be fed to the first reactor). Optionally, it may be mixed with ammonium salt solution that has been regenerated in the second reactor. In the additional mixing vessel the components react to produce a solution comprising additional ammonium chloride, and this may be passed back to the first reactor.

Also disclosed herein is a power station utilising a process and/or system as disclosed and set forth above.

### BRIEF DESCRIPTION OF THE DRAWINGS

Embodiments of the process and system as set forth in the Summary will now be described, by way of example only, with reference to the accompanying drawings, in which:

FIG. 1A is a schematic of a carbon dioxide sequestration process and system according to a first embodiment, appropriate for when the carbon dioxide is contained in flue or other gases at or near atmospheric pressure;

FIG. 1B is a schematic of a carbon dioxide sequestration process and system according to a second embodiment, appropriate for when the carbon dioxide is contained in gas streams at elevated pressures;

FIG. 2 is a schematic illustrating a process and system for the production of ammonium chloride, from a brine of common salt, and ammonia, appropriate for embodiments when ammonium chloride is the ammonium salt used in the silicate rock leaching process. In this embodiment, sodium bicarbonate and sodium carbonate (soda ash) can be produced as by-products.

### DETAILED DESCRIPTION OF SPECIFIC EMBODIMENTS

In the following description, embodiments of the process and system are described in the context of capture of carbon dioxide contained within flue gases emitted by a fossil fuel-fired power station. However, it is to be understood that the process and system may equally be employed for the capture of carbon dioxide from any ‘point’ source and are not limited to the particular arrangements described herein.

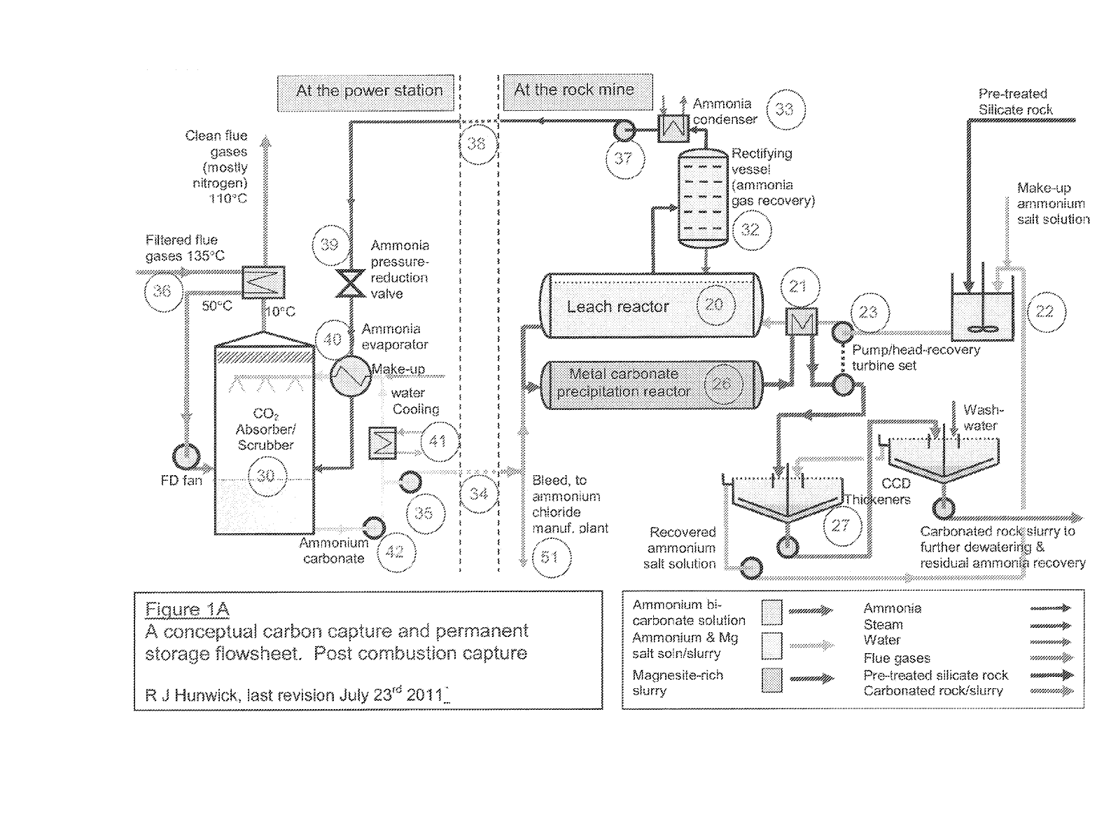

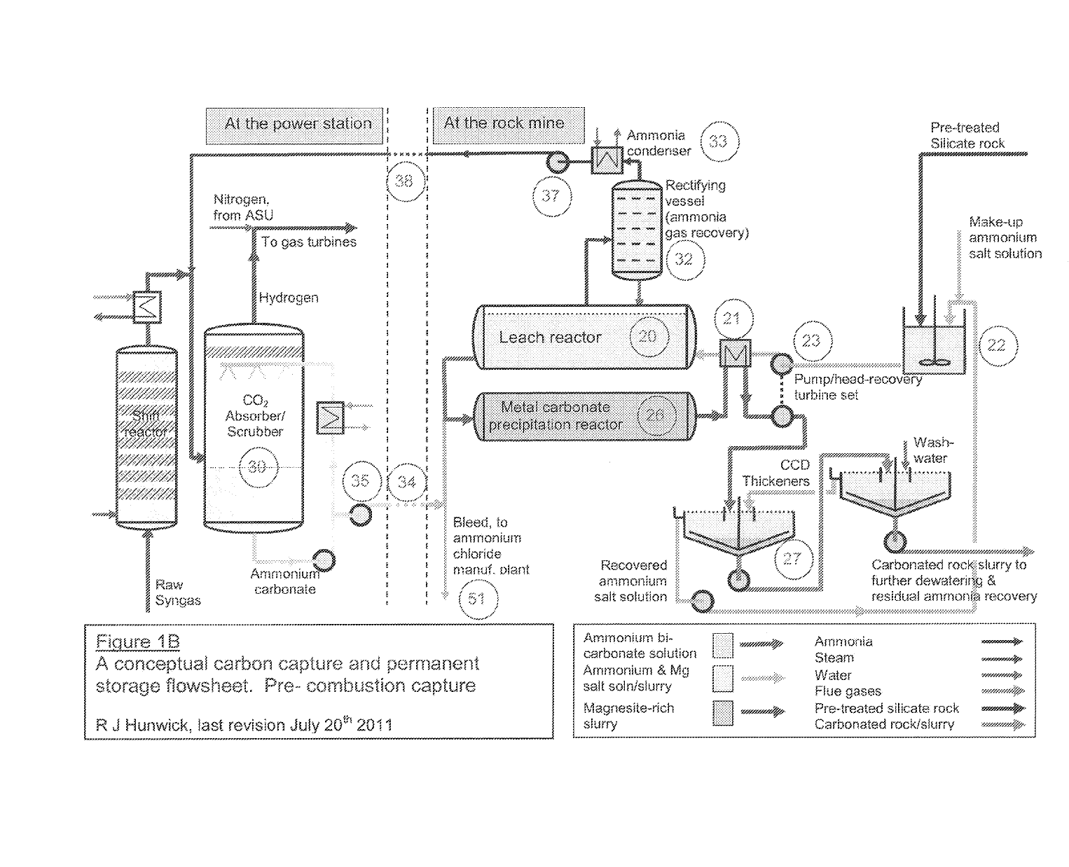

With reference to FIG. 1A there is shown a flow diagram of a System 10 for performing a carbon dioxide (CO₂) capture process from a gas feed stream containing carbon dioxide outputted from a power station, in accordance with a first embodiment. The embodiment depicted in FIG. 1B differs from the flow diagram shown in FIG. 1A in that the gas feed stream is at an elevated pressure (e.g. 25 Bar gauge). Such may occur with gas feed streams gas stream produced by a water gas shift reactor (e.g. that has been fed with syngas, or a stream of raw natural gas that is contaminated with carbon dioxide). In the embodiment depicted in FIG. 1B the ammonia gas may also be pre-mixed with the gas feed stream before being fed or injected into a scrubbing stage. Otherwise, like reference numerals in FIG. 1B denote similar or like parts to FIG. 1A.

The System 10 comprises various apparatus as described herein, arranged to perform a Process 100 of reacting a metal silicate rock with a solution in water of ammonium salts to form a metal salt/silica/water slurry plus ammonia. The system and process are operated such that the ammonia is made or allowed to boil off as a gas out of the metal salt/silica/water slurry in a first leach reactor. In the system and process a gas stream containing carbon dioxide is scrubbed with a solution of ammonia and ammonium carbonate in water to form ammonium carbonate in solution. This solution is produced directly using, inter alia, ammonia captured from the first leach reactor. In the system and process the metal salt in the slurry from the first reactor is reacted with the ammonium carbonate solution from the scrubbing apparatus in a second precipitation reactor to form an insoluble metal carbonate precipitate and to regenerate the solution in water of ammonium salts.

In the embodiments of the system and process depicted in FIGS. 1A and 1B, the first leach reactor and the second precipitation reactor are located at a mine or quarry for the metal silicate. Further, in FIGS. 1A and 1B, the scrubbing apparatus is located at a point source (e.g. power station) for the carbon dioxide-containing gas stream. Thus, only ammonia gas needs to be sent (e.g. piped) from the first leach reactor to the scrubbing apparatus. In addition, only an ammonium carbonate solution produced in the scrubbing apparatus needs to be sent (e.g. piped) back to the second reactor.

The ammonia released from the first leach reactor is concentrated by distillation and is condensed under pressure to form a liquid that contains at least 70% ammonia by weight, with the balance being water, which is also condensed to liquid state. The liquefied ammonia is then pumped under pressure overland from the location of the first leach reactor to the location of the scrubber(s) at the point source.

The flue gases at the point source can be contacted with a circulating flow of water or dilute solution that may be chilled to the extent necessary, in a vessel, and in a counter-current, staged manner. Thus, residual ammonia in the scrubbed flue gases can be further scrubbed from these gases, to levels low enough to allow their final discharge into the atmosphere.

The chilling can be provided by allowing pressurised liquid ammonia to pass through a pressure-reduction valve to reduce its pressure from that of the pipeline (e.g. at least 15 Bar gauge) to close to atmospheric pressure. In passing through the valve some of the ammonia flashes to a vapour. The latent heat of vaporization for the ammonia that evaporates is drawn from the balance of the ammonia, thereby chilling the balance of the ammonia to temperatures well below 0° C. In an embodiment, the circulating flow of water or dilute solution passes through banks of tubes arranged in the form of an enclosed heat exchanger (an ammonia evaporator). The exterior of the pipes or tubes is exposed to supercooled ammonia, which continues to vaporize as latent heat of vaporization is drawn through the tube walls, thereby chilling the circulating flow of water/dilute solution.

The ammonia from the ammonia evaporator, still at a temperature close to 0° C. passes to the inlet of the scrubbing vessel (a CO₂ absorber/scrubber) where it mixes with the filtered flue gases from the power station boilers. The mixing may occur in the absorber/scrubber (FIG. 1A), or prior to feeding into the absorber/scrubber (FIG. 1B), or may even occur in a solution circulating through the absorber/scrubber.

The ammonia from the ammonia evaporator, being at such a low temperature, can further cool the flue gases, now a mixture of flue gases plus ammonia. The point source flue gases fed to the absorber/scrubber can be cooled by passing them counter-currently through a heat exchanger, through which passes scrubbed (i.e. of their CO2 content) flue gases from the absorber/scrubber. These scrubbed flue gases will have also been cooled by the action of the chilled water/dilute solutions that are sprayed into the upper reaches of the absorber/scrubber, to thereby control ammonia slip.

The system and process may further comprise a stage of classifying crystals of metal carbonate in order to control the growth of the crystals of metal carbonate, to aid their subsequent dewatering and recovery of ammonium salts from the metal carbonate and silica cake that is the form in which the carbon dioxide is ultimately stored.

The system and process may further comprise a stage of separating by filtration and/or other solids-liquids separation process the insoluble content including the metal carbonate plus silica, of the slurry from the second precipitation reactor to form a filter cake plus a clear ammonium salts solution that is capable of being recycled back to the first leach reactor.

The system and process may further comprise a stage in which the slurry of metal salt solution plus silica from the first leach reactor is first filtered to remove the insoluble particles present, which will be mainly silica, to form a silica cake, plus a clear solution of metal salts that would instead, proceed to the second precipitation reactor. An instance where this may be favoured is where it is found that the silica particles have properties that make them valuable to third parties (e.g. high porosity and vast surface area that reduces their density substantially, and enhances their ability to clean polluted streams; in a manner similar to charcoal and other forms of activated carbon; or to be used as a lightweight aggregate; or, when appropriately treated, as construction materials such as bricks or blocks).

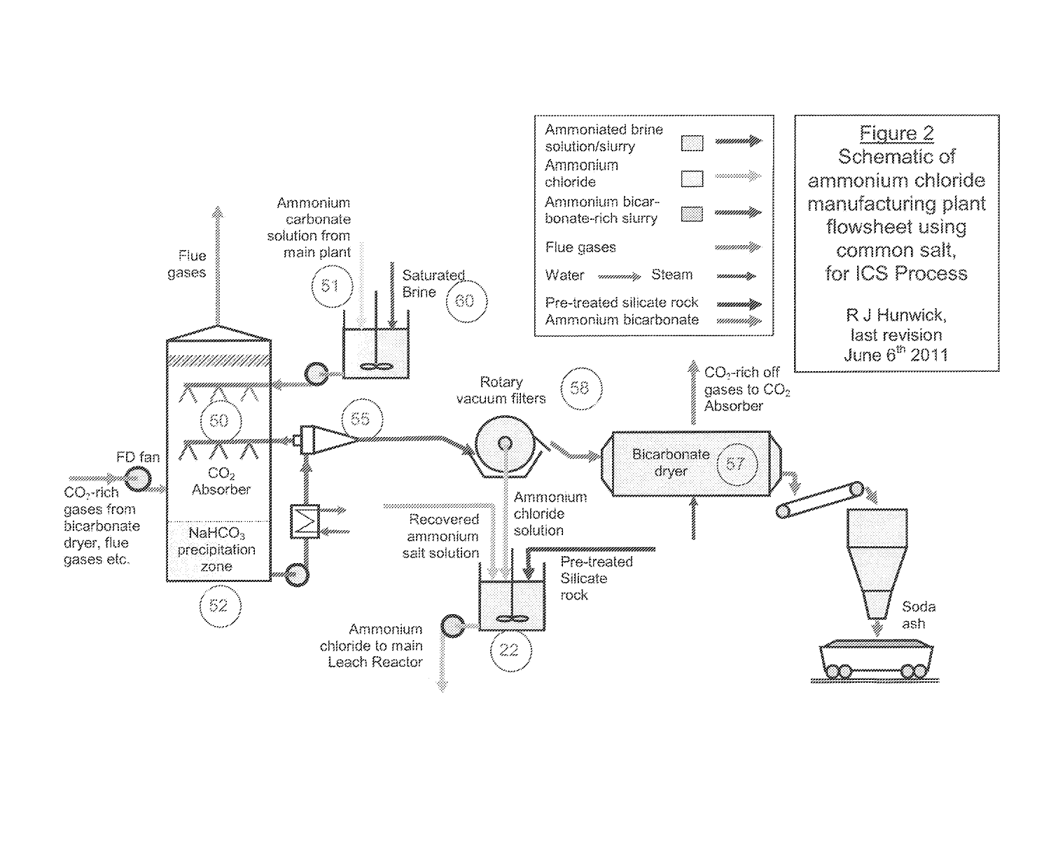

FIG. 2 shows an optional stage of the system and process, namely a stage for producing or manufacturing ammonium chloride in quantities sufficient to make up for losses of ammonium salts that may possibly occur in the final filter cake. The ammonium chloride manufacturing stage employs a brine of common salt, plus a proportion (e.g. typically small) of ammonium carbonate from scrubbing, with the production of potentially valuable by-products, sodium carbonate (soda ash) and bicarbonate. Some of the processes to be employed in the manufacturing ammonium chloride are known to practitioners of the Solvay (ammonia-soda) process for the manufacture of sodium bicarbonate from brine and ammonia, although that process is modified. In this regard, the process does not proceed to the implementation of the second part of the Solvay Process, in which lime is used to recover ammonia from the ammonium chloride. Rather the ammonium chloride is recovered for return to the first leach reactor and to make up for losses (if any) in the final carbonated mineral cake.

The system and process typically comprises a stage occurring prior to the first leach reactor, where the metal silicate rock is pre-treated by crushing, screening and grinding to a maximum particle size of 200 microns. In an embodiment, the finely ground rock, so far dry, can be blended with water or with filtrate from the filter presses and then stored in agitated tanks in the form a dense slurry, suitable for transfer to the first leach reactor.

Leaching of Metals from Rock

In the illustrated embodiments of FIGS. 1A and 1B the leaching of metal silicate is performed within a first Leach Reactor 20. In both FIGS. 1A and 1B this reactor is shown only schematically. In embodiments this reactor 20 may be in the form of a pipeline of appropriate length, or a series of enclosed stirred tanks, and may be installed at or near the surface, or at a depths underground sufficient to place the contents of the reactor under pressure from static head to facilitate conditions for the metal leach reactions to take place, according to equations (1a) (serpentinite), (1b) (olivine) and (1c) (wollastonite):

Mg₃Si₂O₅(OH)₄+6NH₄Cl→3MgCl₂+2SiO₂+6NH₃+5H₂O (1a)

Mg₂SiO₄+4NH₄Cl+→2MgCl₂+SiO₂+4NH₃+2H₂O (1b)

CaSiO₃+2NH₄Cl+→CaCl₂+SiO₂+2NH₃+H₂O (1c)

According to FIGS. 1A and 1B, the Leach Reactor 20 may be connected to a heat exchanger 21, allowing the Reactor 20 to operate at temperatures higher than ambient.

Also according to FIGS. 1A and 1B, the Leach Reactor 20 may be connected to a pressure-exchange arrangement 23, which may be pump driven by a hydraulic turbine together with an electric motor, all on a single shaft (or a series of such pump-turbine motor combinations), allowing the Leach Reactor 20 to be controlled to operate at pressures higher than ambient.

The pre-treated metal silicate and the solution of ammonium salts (which may include ammonia) are blended in the mixing vessel 22, to form a slurry. This slurry is raised in pressure by the pumping part of the pressure-exchange set 23, and heated by hot slurry exiting the Metal Carbonate Precipitation Reactor 26. The reactions taking place in the Leach Reactor 20, including those described by Equations (1a), (1b) and (1c) are exothermic, and some of this heat boils off the ammonia formed by way of Equations (1a), (1b) and (1c), with the balance of the heat transferred to incoming slurry via the heat exchanger 21, in turn cooling the ammoniated slurry as it exits the Leach reactor 20. The pressure and temperature in the Leach reactor 20 are adjusted to maximise the rate of reaction. For example, the temperature is maintained at around 225° C. and the pressure is maintained at around 25 Bar.

Ammonia plus some water formed under the conditions in the Leach Reactor 20 are vaporised, and escape from the Leach Reactor as a vapour mixture. They are passed to a distillation column, in this case a Rectifying vessel 32. In this vessel 32 the flow of vapour is divided into two streams, which ultimately become two liquid streams. One is the bottoms, predominantly water, which flows from the bottom of the column, optionally back to the Leach Reactor 20. The other is the tops, predominantly ammonia, which is condensed under pressure in the Ammonia condenser 33. Much of the latent heat from the condensation of the ammonia and water vapour in the Ammonia condenser 33 may be transferred to a pressurised working fluid, to high-pressure vapour, and can generate electricity according to the Rankine Cycle.

The Rankine Cycle may be a variant known as the Kalina Cycle, and can use an ammonia-water solution as the working fluid (the electricity generation equipment and balance of plant are not shown on FIG. 1A or 1B).

The products of the Leach reactor 20, corresponding to the right-hand sides of Equations (1a), (1b) and (1c), still at a high temperature, and under almost the same pressure as the contents of the Leach reactor 20 (e.g. 225° C. and 25 Bar) are blended with a solution of ammonium carbonate from the power station by way of the Pipeline 34 and Overland solution transfer pumps 35.

The two streams after blending can be at a temperature of 150° C. or higher, and still under approximately 25 Bar pressure, as they enter the Metal carbonate precipitation reactor 26. In this reactor 26, the following reactions may occur:

MgCl₂+(NH₄)₂CO₃→MgCO₃+2NH₄Cl (2a)

CaCl₂+(NH₄)₂CO₃→CaCO₃+2NH₄Cl (2b)

Following passage through the Metal carbonate precipitation reactor 26, the slurry, comprised of a mixture of in the main, metal carbonate (insoluble), silica (insoluble), and a solution in water of ammonium chloride, is then cooled, its sensible heat being substantially transferred to incoming slurry to the Leach reactor 20 via the heat exchanger 21, and de-pressurised, its pressure head being substantially transferred to incoming slurry via the Pump/head recovery turbine pressure exchange set 23.

### Absorption of Carbon Dioxide

In the illustrated embodiment in both FIGS. 1A and 1B, the liquid ammonia from the Ammonia condenser 33 is pumped under pressure from the metal silicate rock mine via the pump 37 and pipeline 38 to the point source of carbon dioxide e.g. a coal-fired power station. The length of the overland pipeline will depend upon the distance separating the mine from the power station or other point source of carbon dioxide, but could range from being adjacent to each other, to 200 kilometres or even more.

On the site of the power station or other point source, the flue gases enter a scrubbing vessel, the CO₂ Absorber 30. In an embodiment, this vessel may be divided into upper and lower zones, although as shown in FIGS. 1A and 1B in practice there is little by way of physical separation between the two zones.

Referring to FIG. 1A the lower zones of the vessel receive flue gases that have been cleaned of the bulk of their burden of particulate solids (e.g. of fly ash) and that have been cooled in the Gas-gas heat exchanger 39, through which passes counter-currently, final flue gases that have been chilled to minimise their content of free ammonia. As heat is transferred, the final flue gases are warmed to a temperature well above the temperature required to eliminate any risk of formation of a vapour plume over the top of the stack (e.g. in excess of 100° C.). In turn, the raw flue gases are cooled to a temperature which is close to, or even below their dew point (e.g. to around 45° C.). If cooled below their dew point, water droplets resembling fog will form in the flue gases. The lower zones of the vessel also receive ammonia as a chilled gas or vapour, at a temperature close to 0° C. It may enter the vessel either separately (solid line on FIG. 1A) or be injected upstream into the filtered flue gases upstream of the vessel (dashed line on FIG. 1A). This ammonia is the same ammonia as arrives onto the power station site via the Overland pipeline 38.

In one form of CO₂ Absorber 30, batteries of pumps 42 circulate a scrubbing solution through the Absorber 30, the solution flowing downwards counter-current to the flow of flue gases upwards. This solution, which starts out as mainly water, rapidly absorbs ammonia, to form ammonium hydroxide. This promptly combines with carbon dioxide in the flue gases, to form a solution of ammonium salts including ammonium carbonate and bicarbonate. In the upper zones of the Absorber, in an embodiment, the carbon dioxide is in greater concentration than ammonia available to combine with it, which will tend to favour the formation of ammonium bicarbonate:

NH₃+H₂O→NH₄OH (3a)

NH₄OH+CO₂→NH₄HCO₃. (3b)

This ammonium bicarbonate will remain in solution, so that the scrubbing solution as it circulates is first converted from what started out as a make-up stream of relatively pure water, to a solution of ammonium bicarbonate.

As the solution is circulated through the lower zones of the CO₂ Absorber 30, in an embodiment it encounters higher concentrations of ammonia, such that while more carbon dioxide will continue to be absorbed via equation (4b), the tendency will be for the ammonium bicarbonate to react with further ammonia to form the normal ammonium carbonate:

NH₄HCO₃+NH₃→(NH₄)₂CO₃ (3c)

It is important to ensure that losses of ammonia in the final flue gases discharged to the atmosphere are below acceptable thresholds, which may be taken as being below one part per million by volume (1 ppmv). To achieve this, the circulating flow of scrubbing solution through the upper zones of the CO₂ Absorber 30 is chilled to below 7° C.; as it passes downwards through the flue gases rising from the lower zones of the CO₂ Absorber 30 these gases are sub-cooled in such a way that ammonia will tend to pass from the otherwise by now clean flue gas to the liquid (chilled circulating solution) phase.

In an embodiment the chilling is provided by allowing the liquid ammonia when it first arrives on the power station site via Pipeline 38 to pass through the Ammonia pressure-reduction valve 39 to reduce its pressure from that of the Pipeline 38 (in an embodiment at least 15 Bar gauge) to close to atmospheric pressure. In passing through the valve 39 some of the ammonia flashes to a vapour. The latent heat of vaporization for the ammonia that evaporates is drawn from the balance of the ammonia, thereby chilling the balance of the ammonia to temperatures well below zero Celsius. In an embodiment, the circulating flow of dilute scrubbing solution passes through banks of tubes arranged in the form of an enclosed heat exchanger: the Ammonia evaporator 40. The exteriors of the tubes are exposed to supercooled ammonia, which continues to vaporize as heat is drawn through the tube walls from the circulating solution thereby chilling it. In an embodiment, the exterior of the tubes are finned to increase their effective gas-to-tube heat transfer area.

The ammonia exhausting from the Ammonia evaporator 40, still at a temperature close to 0° C., is blended into the flow of filtered flue gases or passes directly into the inlet zone of the scrubbing vessel 30 (the CO₂ Absorber/scrubber) as described earlier.

In the lower zones of the CO₂ Absorber 30, the dissolution of ammonia into the initially dilute circulating scrubbing solution, and then the absorption of carbon dioxide into this solution, ultimately converts this into a concentrated solution of normal ammonium carbonate, all as per Equations (3a), (3b) and (3c). The formation of this solution is accompanied by the release of substantial quantities of low-grade heat energy. It is necessary therefore to continuously cool the circulating flow of solution through the lower zones of the CO₂ Absorber by passing it through a Heat exchanger 41 that is in turn, cooled by water that has been cooled in an evaporative cooling tower, or in an air-cooled radiator, or a hybrid air- and water-cooled cooling tower (not shown in FIG. 1A or 1B).

The high volumetric flows of scrubbing solutions required through all zones of the CO₂ Absorber are achieved by the batteries of pumps 42.

In an embodiment, the pumps 42 is at least two pumps installed in parallel, so that should the flow of ammoniated slurry passing downwards through the CO₂ Absorber 30 fall below a minimum prescribed limit for the correct operation of the CO₂ Absorber 30, the second pump would automatically enter service. In an embodiment, there may be many pumps 42 operating in parallel, all to facilitate more precise process control over the operations of the Process 100.

### Recovery of Valuable Solutes

The slurry from the Magnesite precipitation reactor 26, a mixture of a solution in water primarily of ammonium chloride, in which are suspended particles of magnesite and silica, after cooling in Heat exchanger 21 and its pressure reduced via the Pressure-exchange set 23, is subjected to one or more solids-liquids separation processes to remove insoluble solids with minimum content of ammonium chloride and other solubles, to yield a concentrated solution of ammonium chloride and other solubles largely free of suspended solids.

In the embodiment depicted in FIGS. 1A and 1B, the solids-liquids separation processes can be a series of equipment items: a series of two or more Counter-current decantation (CCD) thickeners 27, followed by a battery of plate and frame filter presses (not shown in FIG. 1A or 1B). For example, the number of stages of CCD thickeners 27 can be four or more. Alternatively, the filters can be rotary vacuum filters enclosed to prevent the escape of ammonia into the ambient environment. In a further alternative the filters can be batteries of decanter-type centrifuges.

Washing facilities may be included in the dewatering filters or other solids-liquids separation systems, to sharpen the separation between the ammoniated solution and the insoluble solids, hence improving the recovery (minimising losses) of ammonia and ammonium salts along with the insoluble solids (the carbonated mineral cake).

Pre-Cleaning of Raw Flue Gases

In the embodiment of FIG. 1A, the flue gases from a coal-fired power station or similar are subjected to a number of processes. Flue gases from modern coal-fired power stations are typically cleaned of particulate matter (fly ash) by processes familiar to those in the industry, e.g. by fabric filtration or electrostatic precipitators. Increasingly, flue gas streams are further purified by scrubbing with a slurry of limestone in water, or other process, designed to remove most of the oxides of sulphur (referred to as SOx) that are a consequence of the combustion of reduced sulphur present in coal (e.g. metal sulphides such as iron pyrite FeS₂, and organic forms of sulphur such as mercaptans). Additionally, modern coal-fired power stations are increasingly required to remove as much as possible of another pollutant contained in raw flue gases: oxides of nitrogen, namely, a mixture of nitric oxide NO, and other oxides including the dioxide NO₂, trioxide N₂O₃, and tetroxide N₂O₄, collectively referred to as NOx.

Hence in a situation where the Process 100 is intended to be retrofitted to an existing coal-fired power station or similar point source to capture and store permanently most of the carbon dioxide formed from the combustion of the coal or other carbon-containing fuel, the flue gases 36 may be at least substantially free of dust particles, and may be largely free of SOx and of NOx.

It is important to note that the Process 100 does not require that flue gases be substantially free of particulates, or SOx or NOx. The Process 100 works correctly even if none of these pollutants have been removed beforehand. In fact unless the coal is particularly high in sulphur (e.g. more than 2% by weight as S) it is more logical that no attempt is made to remove SOx ahead of the Process 100. If not removed, fly ash may simply pass through the Process essentially unaltered, except that any free alkali present either as quicklime CaO or magnesia MgO (common constituents of many fly ashes) can combine with anions present in the ammoniated slurry, including sulphate and nitrate, to form additional calcium and magnesium salts, according to Equation (7) (shown for calcium):

MgO+H₂O→Mg(OH)₂

2NH₄Cl+Mg(OH)₂→MgCl₂+2NH₄OH (7)

As previously described, it will be apparent that these reactions are the same as occur elsewhere in the Process 100, and do not affect its operation. However, fly ash may be advantageously removed beforehand because it has value in other markets when in a dry form (e.g. for use in concrete formulations). It is not, however, necessary to insist on removal of 99.9% of fly ash, as is required to meet particulate emissions limits; 99% removal would be entirely adequate, as subsequent fly ash particles will be removed in the CO₂ Absorber 30.

In the course of passage through the CO₂ Absorber 30, the SOx contained in raw flue gases can be converted via a series of reactions to sulphuric acid:

SO₂+H₂O→H₂SO₃ (sulphur dioxide forms sulphurous acid) (8a)

SO₃+H₂O→H₂SO₄ (sulphur trioxide forms sulphuric acid) (8b)

2H₂SO₃+O₂→2H₂SO₄ (oxygen oxidises sulphurous to sulphuric acid) (8c)

The sulphuric acid immediately reacts with the large excess of ammonia present in the solution circulating through the CO₂ Absorber 30 (mostly as ammonium hydroxide with some ammonium carbonate from the capture of carbon dioxide in the flue gases) flowing through the CO₂ Absorber to form ammonium sulphate:

2NH₄OH+H₂SO₄→(NH₄)₂SO₄+2H₂O (9)

In the course of passage through the CO₂ Absorber 30, the NOx contained in raw flue gases can be converted via a series of reactions to nitric acid, most probably via the following reactions due to the low-temperature conditions occurring in the upper parts of the CO₂ Absorber 30:

2NO+O₂→N₂O₄ (nitrogen tetroxide formed) (10a)

N₂O₄+H₂O→HNO₂+HNO₃ (mix of nitrous and nitric acid formed) (10b)

2HNO₂+O₂→2HNO₃ (oxygen oxidises nitrous to nitric acid) (10c)

The nitric acid immediately reacts with the large excess of ammonia present in solution in the circulating solution (mostly as ammonium hydroxide with some ammonium carbonate from the capture of carbon dioxide in the flue gases) flowing through the CO₂ Absorber to form ammonium nitrate:

NH₄OH+HNO₃→NH₄NO₃+H₂O (11)

The ammonium nitrate and sulphate formed in solution will add to the circulating flow of primarily ammonium carbonate formed in the CO₂ Absorber, entering the mixing vessel 22 and subsequently pumped overland to the rock mine via the pump 35 and overland pipeline 34.

Since some of these anions: chloride, sulphate and nitrate, are inevitably lost from the solids-liquids separation system (collectively the CCD thickeners 27 and filter presses 29) the rate that sulphate and nitrate anions are added to the circulating flow reduces the quantities of chloride ions that must be added to make up for losses. In the Process 100, the ammonium salts of chloride, sulphate and nitrate anions are all acceptable anions, and are interchangeable, without affecting operation of the process.

It follows that, far from being a liability to the Process 100, the presence of SOx and NOx in raw flue gases may be seen to be a bonus, partially making good the losses of chloride, sulphate and nitrate anions from the Process 100 via the final carbonated mineral once it has been permanently emplaced.

It also therefore follows that a new power station, fitted from the outset with the Process 100 to capture and permanently store the carbon dioxide produced from the combustion of the fuel, need not be equipped with separate and typically expensive plant and equipment for the removal of more than 99 per cent of particulates, or for the control or removal of SOx and NOx. This promises a significant cost saving compared with other CCS processes that need to be fed with flue gases that contain essentially no particulates, SOx or NOx.

It should be noted that the recovered ammonium salt solution, prior to entering the blending tank 22, can be treated to recover any heavy metals or other soluble materials that have built up in concentration in the system because of the constant recycling through the Process 100 of ammoniated salts.

It will be apparent from this description that the Process 100 can be effective for removing the normal range of pollutants in the flue gases of coal-fired power stations and other point sources: SOx, NOx and particulates, and even volatile metals such as mercury, that would be substantially condensed out of the flue gases in the cool environment of the upper zones of the CO₂ Absorber 30.

In the fullest sense, the System 10 and Process 100 may be viewed as a complete multi-pollutant control system and process for the cleaning of flue gases from coal-fired power stations and other point sources, to the extent where the final flue gases discharged to the atmosphere are comprised of around 95 per cent nitrogen (including argon and other inert gases normally present in the atmosphere), plus some residual oxygen (perhaps 3.5%) and residual carbon dioxide (around 1.5%), namely, the balance after 90% of the original quantity present had been captured (all percentages by volume).

### Differences Between Embodiments of FIGS. 1A and 1B

In the embodiment shown in FIG. 1B, the reactions are the same as occur with those described for the embodiment of FIG. 1A. However, there are differences between the compositions of the raw gases containing carbon dioxide that are to be scrubbed in the CO₂ Absorber 30. For example, the raw gases may contain hydrogen sulphide. Where, for example, the raw gas is the product of the gasification of coal, or heavy fuel oil, or raw natural gases from ‘sour’ wells, hydrogen sulphide is a usual form of sulphur found in the raw gas stream containing carbon dioxide to be scrubbed. In the embodiment of FIG. 1B, the ammonia gas returned from the Leach Reactor 20 can be mixed with the raw gases containing hydrogen sulphide. In such case the hydrogen sulphide can be stripped from the raw gas by the ammonia in solution to form ammonium hydrosulphide in solution. Upon exposure to air, this compound is oxidised to form elemental sulphur as a precipitate, plus the salt ammonium thiosulphate, which remains in solution. While none of these materials is in any significant way harmful to the operation of the Process 100, it is preferable that, when hydrogen sulphide to be present in the raw gases in more than trace quantities, the sulphur content be removed upstream of the gas entering the Process 100 by processes well known to persons skilled in the art (e.g. the Stretford Process).

### Manufacture of Ammonium Chloride

Ammonium chloride in the quantities required to make up for losses of all anions in the final carbonated mineral, can be manufactured from brine according to the process shown in depicted in FIG. 2.

The process shown in FIG. 2 resembles closely a part of the process used for the production of sodium bicarbonate (NaHCO₃) by the ammonia-soda or Solvay Process, which has been operating commercially for more than 150 years. However, when applied to the Process 100, and as shown as FIG. 2, saturated or near-saturated sodium chloride brine is blended with ammonium carbonate solution 51 that is bled in the correct quantity from the main circulating flow shown in FIGS. 1A and 1B. The blend is used as a scrubbing medium in the CO2 Absorber 50 (which can resemble the CO2 absorber 30 of FIG. 1A). Carbon dioxide, first from the decomposition of sodium bicarbonate in the Bicarbonate dryer 57 and, as necessary, by way of a bleed of flue gases from the main power station or other point source, reacts with the ammonium carbonate/brine solution, whereupon a precipitate of sparingly soluble sodium bicarbonate finals. This is filtered out, leaving ammonium chloride in solution, all according to the following equation:

(NH₄)₂CO₃+2NaCl+CO₂→2NaHCO₃+2NH₄Cl (11)

However, in the Process 100, the resulting ammonium chloride solution is pumped back to rejoin the main flow of ammoniated slurry circulating through the Process 100, at Blending tank 22 (i.e. the Blending tank 22 of FIGS. 1A and 1B).

In embodiment variation, crystallisation of the sodium bicarbonate precipitate (which is only sparingly soluble under these conditions) can be promoted within the NaHCO₃ precipitation zone 52, in a pool formed beneath the CO₂ Absorber 50, and in the classification of the crystals in the circulating flow, by way of the hydrocyclone batteries 55. The hydrocyclones 55 divide the flow into two streams, with the overflow returning to the CO₂ Absorber, while the underflow (spigot) product reports to a special type of rotary vacuum filter, a bicarbonate filter 58. The sodium bicarbonate filter cake is conveyed to a Rotary drum dryer 57 where it is dried. It may be subjected to further processing including by heating to produce soda ash by the following equation:

2NaHCO₃→Na₂CO₃+H₂O+CO₂ (12)

The carbon dioxide produced by heating the sodium bicarbonate filter cake can be directed back to the CO₂ Absorber 50.

The filtrate (a solution primarily of ammonium chloride) from the rotary vacuum filter 58 can flow into the main Blending tank 22, where it joins the recovered ammonium chloride solution from the main Process 100 (FIGS. 1A and 1B), namely, from the solids-liquids separation plant 27, which also enter the main Blending tank 22. Example

In a non-limiting Example, the following table outlines a mass balance for one example of the Process 100 in practice.

TABLE 1
Indicative mass balance figures from 1.000 MWe of black coal-fired electricity
generation plant, ammonium chloride leach pre-processing of serpentinite.

| Material | Per year (million t) | t per hour |
|---|---|---|
| Total CO₂ generated: | 6.4 | 800 |
| Total CO₂ captured (90% of that generated): | 5.76 | 720 |
| Serpentine required to store this CO₂: | 12.04 | 1,505 |
| Serpentinite rock required (70% activity): | 17.2 | 2,150 |
| Serpentinite weight after heat treatment (10% wt loss) | 15.48 | 1,935 |
| Ammonium chloride to dissolve MgO in rock: | 13.78 | 1,723 |
| NH₃ in solution from Equation 2) | 4.46 | 558 |
| NH₃ reqd, to capture 5.76 mt CO₂ as NH₄HCO₃ | 2.23 | 279 |
| NH₃ reqd, to capture 5.76 mt CO₂ as (NH₄)₂CO₃ | 4.46 | 558 |
| Water in soln from Equation 2) with H₂O:NH₃ ratio 3/2 | 7.08 | 885 |
| Total flux into and out of Leach reactor | 35.70 | 4,460 |
| Total flue gases entering CO₂ Absorber, dry | 32.0 | 4,000 |
| Total flue gases entering CO₂ Absorber, wet | 33.76 | 4,220 |
| Total moisture in raw flue gases | 1.76 | 220 |
| Final flue gases, dry basis | 28.0 | 3,500 |
| Final flue gases, wet basis | 28.28 | 3,535 |
| Water in final flue gases: | 0.28 | 35 |
| Water vapour removed from flue gases | 1.32 | 165 |
| Carbonated rock produced: | 21.4 | 2,675 |
| Total flux to washing/dewatering plant from carbonation: | 40.0 | 5.000 |
| Total aqueous phase in dewatering plant feed: | 18.6 | 2,325 |
| Insol. solids concentration in dewatering plant feed: | 53.5% | 53.5% |
| Total washwater added in dewatering plant | 0 | 0 |
| Total filter cake, 85% insol. solids: | 25.18 | 3,147 |
| Total aqueous phase in filter cake: | 3.78 | 473 |
| Recovery of solutes in aqueous phase, no washing, % | 80% | 80% |
| Total ammonium chloride in aqueous phase, no wash: | 13.78 | 1,723 |
| Total amm. chloride lost in filter cake, 80% recovery | 2.76 | 345 |
| Total amm. chloride lost in filter cake, 98% recovery | 0.276 | 34.5 |
| Total NOx in flue gases, 400 ppm by wt (as NO) | 0.0113 | 0.14 |
| Total NOx in flue gases, 400 ppm by wt (as NH₄CL) | 0.030 | 0.38 |
| Total SOx in flue gases, 0.65% S in coal (as SO₂) | 0.0284 | 0.355 |
| Total NOx in flue gases, 0.65%S in coal (as (NH₄)₂SO₄) | 0.103 | 1.287 |
| Total amm. nitrate & sulphate (as NH₄Cl): | 0.102 | 1.27 |
| Recovery required for no make-up of NH₄Cl: | 99.26% | 99.26% |
| Make-up of NH₄Cl required, 80% recov, non-coal: | 2.76 | 345 |
| Make-up of NH₄Cl required, 80% recov, coal: | 2.66 | 332 |
| Make-up of NH₄Cl required, 98% recov, non-coal: | 0.276 | 34.5 |
| Make-up of NH₄Cl required, 80% recov, coal: | 0.174 | 21.8 |
| Salt to make up for NH₄Cl losses, 80% recov, non-coal: | 3.06 | 384 |
| Salt to make up for NH₄Cl losses, 80% recov, non-coal: | 0.306 | 38.4 |
| Sodium bicarbonate manufactured, 80% recovery, non-coal: | 5.17 | 64.6 |
| Sodium bicarbonate manufactured, 98% recovery, non-coal: | 0.517 | 6.46 |
| Sodium carbonate manufactured, 80% recovery, non-coal: | 3.26 | 40.8 |
| Sodium carbonate manufactured, 98% recovery, non-coal: | 0.326 | 4.08 |
| Total losses of ammonia in NH₄Cl, 80% recov non coal: | 0.894 | 11.7 |
| Total losses of ammonia in NH₄Cl, 98% recov, non-coal: | 0.089 | 1.17 |
| Total losses of ammonia in NH₄Cl, 90% of 98% recov: | 0.009 | 0.117 |
| Ammonia recovered (90% in cake), 80% recov, non-coal | 0.805 | 10.1 |
| Ammonia recovered (90% in cake), 80% recov, non-coal | 0.0805 | 1.01 |
| Washwater reqd for 80% recov. of NH₄Cl: | 0 | 0 |
| Washwater reqd for 98% recov. of NH₄Cl: | 4.8 | 60 |
| Water lost in cake, 80% recov. of NH₄Cl: | 2.36 | 29.5 |
| Water lost in cake, 98% recov. of NH₄Cl: | 3.64 | 45.5 |
| Total water to be removed: coal, 98% recov: | 2.48 | 31.0 |
| Total water to be removed: dry flue gases, 98% recov: | 1.16 | 14.5 |
| Total water to be made up: dry flue gases, 80% recov: | 2.36 | 29.5 |

Table 1 provides an indicative detailed mass balance for a carbon dioxide sequestration process, assuming:
90 per cent carbon dioxide capture and sequestration from 1,000 MWe of black coal-fired electricity generation plant which, when operating in base-load mode, might be expected to generate annually 8,000 GWh of electricity;
where on a dry ash-free basis, the coal is 81.3% by weight carbon and 0.65% sulphur (as S) and the flue gases contain 400 ppm NOx;
where between 80% and 98% of the solubles in the product of the ammoniated slurry flowing to the dewatering plant is recovered;
where anions lost with the final carbonated mineral cake are made up by chloride ions in the form of ammonium chloride, net of any nitrate and sulphate ions formed as a consequence of SOx and NOx impurities in the raw flue or other gases that enter the CO₂ Absorber;
where the ammonium chloride is manufactured in a separate plant by absorbing ammonia into a concentrated solution of common salt such as seawater brine from a desalination plant, and this ammoniated solution is used to scrub a gas containing carbon dioxide, whereupon a precipitate of sodium bicarbonate results, leaving a solution of primarily ammonium chloride once the sodium bicarbonate has been filtered out;
where 90% of the residual ammonia is removed from the carbonated mineral cake by heating using microwave or other form of energy, and returned to the Process 100.

Whilst a number of specific process and system embodiments have been described, it should be appreciated that the process and system may be embodied in many other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the process and system as disclosed herein.

1. A process for capturing carbon dioxide from a gas stream comprising:
in a first reactor, reacting a slurry of a metal silicate together with an ammonium salt in aqueous solution, being a salt that does not form a precipitate with the metal silicate, such that the metal silicate reacts with the solution to produce a slurry of silica in an aqueous solution of a salt of the metal and ammonia;
drawing off ammonia gas directly from the first reactor;
adding ammonia, including the ammonia drawn off from the first reactor, to the gas stream;
scrubbing the gas stream, including with the added ammonia, with an aqueous solution, whereby the carbon dioxide and ammonia are absorbed into the solution and ammonium carbonate salt(s) are produced.

2. A process in accordance with claim 1, wherein the solution of the metal salt is passed to a second reactor in which it is reacted with the solution of ammonium carbonate salt(s) from the scrubbing stage to form a metal carbonate precipitate and to regenerate the ammonium salt in aqueous solution.

3. A process in accordance with claim 2, wherein at least one of pressure and heat is exchanged between the slurry/solution fed to the first reactor and the solution leaving the second reactor.

4. (canceled)

5. (canceled)

6. A process in accordance with claim 2, wherein a first proportion of the solution of ammonium carbonate salt(s) from scrubbing is recycled back to the scrubbing stage to form at least a part of the aqueous solution used therein; and wherein a second proportion of the solution of ammonium carbonate salt(s) is separated from that which is to be passed to the second reactor, with this second proportion being used to produce an aqueous ammonium salt solution in a separate process stage for eventual recycle to the first reactor.

7. (canceled)

8. A process in accordance with claim 1, wherein the metal silicate and the ammonium salt solution are reacted in the first reactor at an elevated pressure and associated elevated temperature which is near the boiling point of the solution at that pressure.

9. A process in accordance with claim 1, wherein the ammonia gas from the first reactor is separated from any accompanying water vapour in a distillation column, in which the water vapour is condensed, with at least some of the condensed water being returned to the first reactor; with the ammonia gas from the distillation column being condensed under elevated pressure, transferred as a liquid and, prior to scrubbing, being allowed to expand to be fed as a gas to the scrubbing stage; and, following expansion, the ammonia is passed through a heat exchanger to cool the aqueous solution to be used in scrubbing.

10. (canceled)

11. (canceled)

12. A process in accordance with claim 1, wherein, during scrubbing, the ammonia gas and the gas stream are fed into a lower zone of a scrubber whereas the aqueous solution is sprayed from a higher zone of the scrubber.

13. A process in accordance with claim 1, wherein the ammonium salt reacted in the first reactor is one or more of ammonium chloride, ammonium sulphate or ammonium nitrate; such as a by-product of scrubbing of carbon dioxide from flue gas, from a coal-fired power station.

14. (canceled)

15. A process in accordance with claim 13, wherein the separate process stage comprises an ammonium chloride manufacturing process in which the second proportion of ammonium carbonate salt(s) solution is mixed together with brine and is used to scrub a carbon dioxide-containing gas stream, and to produce an aqueous ammonium chloride solution for passing to the first reactor; with the carbon dioxide that is absorbed into the mixed solution reacting with the ammonium carbonate to produce ammonium bicarbonate, which in turn reacts with the chloride of the brine to produce ammonium chloride and a sodium bicarbonate precipitate.

16. (canceled)

17. A process in accordance with claim 15, wherein the sodium bicarbonate precipitate is separated from the solution and is then heated to produce soda ash and to liberate a gas stream of carbon dioxide and water vapour, with this gas stream being recycled to react with and be scrubbed by the mixed ammonium carbonate and brine solution; and wherein the ammonium chloride solution which is separated from the sodium bicarbonate precipitate is mixed with the metal silicate and, optionally, with ammonium salt solution regenerated in the second reactor, to react and produce additional solution comprising ammonium chloride for passing to the first reactor.

18. (canceled)

19. A process in accordance with claim 15, wherein, in the separate process stage, the gas comprising carbon dioxide further comprises a slip stream taken from the gas stream to be scrubbed with ammonia.

20-33. (canceled)

34. A system for enabling carbon dioxide in a gas stream to be captured, the system comprising:
a first reactor for receiving and controlling the reaction of a metal silicate slurry with an ammonium salt in aqueous solution, being a salt that does not form a precipitate with the metal silicate, whereby the metal silicate reacts with the solution to produce a slurry of silica in an aqueous solution of a salt of the metal and ammonia; and
a second reactor for receiving the solution of the metal salt from the first reactor and for controlling its reaction with a solution of ammonium carbonate salt(s) to form a metal carbonate precipitate and to regenerate the ammonium salt in aqueous solution for use in the first reactor.

35. A system in accordance with claim 34 further comprising a separation stage of one or more thickening and/or filtration stages subsequent to the second reactor for separating the silica and metal carbonate precipitate from the regenerated ammonium salt solution to enable the solution to be returned to the first reactor.

36. (canceled)

37. A system in accordance with claim 34 further comprising a scrubbing apparatus for removing the carbon dioxide from the gas stream and absorbing it in ammoniated solution produced from ammonia gas that includes ammonia gas drawn from the first reactor.

38. A system in accordance with claim 37, wherein the ammoniated solution is produced by scrubbing the gas stream with the ammonia together with an aqueous solution, whereby the carbon dioxide and ammonia are absorbed into the solution and wherein the solution of ammonium carbonate salt(s) is produced for passing to the second reactor.

39. (canceled)

40. (canceled)

41. A system in accordance with claim 34, further comprising a heat exchanger and/or a pump/head-recovery turbine, each arranged to operate such that at least one of pressure and/or heat may be exchanged between the slurry/solution fed to the first reactor and leaving the second reactor.

42. A system in accordance with claim 34, further comprising an ammonium chloride manufacturing stage that comprises:
a mixing vessel in which part of the solution of ammonium carbonate salt(s) for the second reactor is instead mixed together with brine; and
a scrubbing vessel in which the mixed solution of ammonium carbonate salt(s) and brine is used to scrub a gas comprising carbon dioxide, and to produce an aqueous ammonium chloride solution for passing to the first reactor.

43. A system in accordance with claim 42, wherein the scrubbing vessel is operated such that the carbon dioxide is absorbed into the mixed solution to react with the ammonium carbonate to produce ammonium bicarbonate, which in turn reacts with the chloride of the brine to produce ammonium chloride and a sodium bicarbonate precipitate.

44. A system in accordance with claim 43, further comprising sodium bicarbonate separation and heating stages wherein:
at the separation stage the sodium bicarbonate precipitate is separated from solution circulating in the scrubbing vessel, firstly at a hydrocyclone, and then at a rotary vacuum filter;
at the heating stage the sodium bicarbonate precipitate from the rotary vacuum filter is heated in a rotary dryer to produce soda ash and to liberate a gas stream of carbon dioxide and water vapour, with this gas stream being recycled to the scrubbing vessel where the carbon dioxide is scrubbed by and reacts with the mixed solution.

45. A system in accordance with claim 44, further comprising an ammonium chloride top-up stage wherein the ammonium chloride solution which is separated at the rotary vacuum filter is passed to an additional mixing vessel where it is mixed with the metal silicate and, optionally, with ammonium salt solution regenerated in the second reactor, to react and produce a solution comprising additional ammonium chloride for passing to the first reactor.

46. (canceled)

47. (canceled)

48. (canceled)
